(19) United States
(12) Patent Application Publication
(10) Pub. No.: US 2014/0297349 A1
(43) Pub. Date: Oct. 2, 2014

(54) Method of and system for determining pricing to ensure profitability and tracking profit on daily basis

(71) Applicant: Terry Morrill, Glendale, CA (US)

(72) Inventor: Terry Morrill, Glendale, CA (US)

(21) Appl. No.: 13/850,538

(22) Filed: Mar. 26, 2013

(51) Int. Cl. G06Q 40/00; G06Q 10/06

(52) U.S. Cl. CPC G06Q 40/12; G06Q 10/063118; G06Q 10/06313
USPC 705/7.17

(57) ABSTRACT

The present invention relates to a business method and system for determining pricing and tracking profit, and relates particularly to a business method and system for determining pricing and tracking profit in the field of building contract business. The business method and system ties ones gross profit to time—which is a coined word GPMD (gross profit per man day). The system maybe a software where contractor can utilize to enter the customer info into the system, do the estimating using the software, then schedule and project the job using the software, make daily adjustments to the schedule, enter the actual labor hours and the actual materials cost into the software, then book the gross profit that they actually made at the end of each day.

### BACKGROUND OF THE INVENTION

1. Field of the Invention

The present invention relates to a business method and system for determining pricing and tracking profit, and particularly to a business method and system for determining pricing and tracking profit in the field of building contract business.

2. Description of Related Art

When running a business the money received from a customer is called Gross Income. This is all the money coming into the company before any expenses are paid. The Gross Income minus Expenses equals Profit, or a “Loss”, meaning the expenses exceed the Income.

There are two types or classes of expenses. The first is called Cost of Goods Sold (COGS). Other names for this are direct expenses or variable expenses. Cost of Goods Sold is simply the expenses directly involved with the delivery of a service or the item you sell. It is the expenses that the business owner pay in order to do a job or project.

In construction that would include materials, labor (including work comp and payroll tax for labor) and sales commissions directly consumed or connected to a particular job. The money left over is called the Gross Profit which is profit #1.

The second type of expense is the Overhead. Overhead is the on-going expenses that are needed to continue a business owner's business operation and that are paid whether the business owner are doing any jobs/projects or not. That is why they are Overhead, because the business owner have to pay them even if the business owner's company has no jobs coming in.

There are several words that mean the same thing as Overhead: Indirect Expenses, Fixed Expenses, Operating Expenses, Nut, etc. It goes by many names and for this system the word Overhead is used.

When talking about labor what is referred to is direct labor (labor required to produce a product). Other labor such as office staff is part of the business owner's Overhead because the business owner have that expense whether the business owner have a job to do or not. The direct labor is usually sent home if there is no work to do. Administrative staff includes all office employees such as secretaries, office managers, receptionists, the business's CFO, the business's marketing department, owner's salary, etc. If the business have a foreman that is on salary, that would be included in the business's Overhead.

In a business these are some expenses the business will have to pay whether the business have paying work or not, for example: Utilities, Phone, Gas, Truck Payments, General Liability Insurance, Office Supplies, Postage, Advertising, Office Staff (including owners salary), Work Comp (for Office Staff), Payroll Tax (for Office Staff), Vehicle Maintenance; the business's Overhead is the Second Expense. What is left over after the business's Overhead is the business's Second Type of Profit, the Net Profit.

In other words, Net Profit is the amount of Gross Profit that is greater than the business's Overhead. Net Profit is the amount of money left over after the business pays the Cost of Goods Sold and the Overhead.

Companies spend countless hours doing job costing on individual jobs but they are missing the one key factor that would tell them if they are making any money. It is important to know that one's overhead is directly connected to time and all estimating systems currently employed do not use time as the only factor to determine ones overhead and profit. Using other factors such as a percent markup of either labor or materials is and error and can lead to insolvency.

Knowing that one needs to cover ones Overhead every day is a target that the company's managers must hit. Other companies consider that a company makes no profit until their annual Overhead is made sometime late in the year like in November or December, but this is a fallacy. Companies don't prepay all of their expenses during the year and take zero profit before November. Companies make profit or Break Even or lose money every day and they should know each day where they stand fand then decide what they are going to do to correct the fact that they are not making any profit or strengthen the fact that they are making Net Profit.

### SUMMARY OF THE INVENTION

It is an object of the present invention to provide a business method and system that can help a contractor to estimate a price of a job and a contractor to see if they made a profit each day.

It is another object of the present invention to establish the fallacy of not tying time to an estimating system and the basic misconception that a construction job can produce overhead or net profits. The fact is a job can only produce GROSS PROFIT. It is up to the managers of the company to make the gross profit cover the overhead and have sufficient money leave over to make the needed net profit to survive.

It is another object of the present invention to provide a business method and system that ties ones gross profit to time—which is a coined word GPMD (gross profit per man day). And as a result creates either Net Profit each day which is another coined word NPMD (Net Profit per Man Day) or Lost “Profit” called LDMD (coined word—Lost Dollars per man Day)

In an exemplary embodiment of the present invention, there is disclosed a business method and system that enables a contractor to estimate the price of a job and allows the contractor to see if they made a profit each day. The method and system comprising a software (web-based) in which a contractor would subscribe to the software on a monthly basis. The contractor would enter the customer info into the system, do the estimating using the software, then schedule and project the job using the software, make daily adjustments to the schedule, enter the actual labor hours and the actual materials cost into the software, then book the gross profit that he actually made at the end of each day. Each and every crew would do the same. It does not matter if there is one two man crew or 50 sets of 5 men crews. At the end of the day once the crew hours and materials that were used are entered into the software program the amount of gross profit that each made can be measured in dollars. If the summation of the gross profit from all the crews exceeds the daily overhead then money was made that day. If the amount is less than the overhead money was lost that day.

According to one embodiment of the present invention, the business system for determining an estimated price and keeping track of a contract job for a contractor comprises: a customer information database for contractor to input customer information; a job scheduler and projector module for inputting jobs and making adjustments to the schedule; a job price estimator module for estimating the price for a job; a database for booking the gross profit; and a database for storing the input labor cost per hour (a), labor hours, material cost (b), GPMD, calculated total labor cost (c), man days, gross profit (d), commission (e).

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. In fact the invention could be used in any business that estimates time to do a project and then charges the customer a flat fee for completing that project. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a Gross Profit per Man Day (“GPMD”) Bar flow chart.

FIG. 2 illustrates the relationship between gross income, cost of goods, gross profit, overhead, and net profit in flow chart fashion.

FIG. 3 illustrates in a flow chart one's overhead bin as well as the definition of breakeven which is when the gross profit is equal to the overhead, the ENEMY which is TIME

FIG. 4 illustrates a chart wherein there are two jobs to choose from

FIG. 5 illustrates how gross profit should be related to time.

FIG. 6 illustrates a man or a production unit as Gross Profit per Man Day or GPMD

FIG. 7 illustrates a flowchart wherein a Production Unit is necessary to fill up ones overhead bin.

FIG. 8 is a daily flow chart of gross profits

FIG. 9A, FIG. 9B, FIG. 9C, FIG. 9D, FIG. 9E, FIG. 9F, FIG. 9G, and FIG. 9H illustrate charts that use dollar amounts of gross profit earned and show what happens to the overhead bin from a day range of zero to seven and these charts further illustrate what happens with overtime days and double overtime days.

FIG. 10 illustrates a graph chart wherein is shown the fallacy to bidding by a unit price ($10 per square foot) and how the line on the graph represents the price correctly bid using the GP Estimating System or the AIMM Estimating System.

FIG. 11 illustrates a flow chart wherein is depicted the relationship of a playing field where the crews are working for wages not production.

FIG. 12 illustrates a flow chart wherein the winning playing field is seen where the crews are working with the owner for production and not time.

FIG. 13 is a flow chart showing how faster progress makes profits

FIG. 14 is a flow chart slowing how progress doesn't cover the overhead

### DESCRIPTION OF THE PREFERRED EMBODIMENT

If a contractor has a first job to remodel customer A's bathroom and the contract amount is $40,000, the cost of the goods sold is $20,000, the overhead per month is $20,000 and the job takes a contractor a month to complete then the contractor would not make any money. They would break even. If the contractor wants to make money he would manage to complete customer A's bathroom in 3 weeks and take on a second job of re tiling bathroom for customer B that has a COGS of $5,000. This results in a $5,000 being left over. Since the contractor already covered his overhead with the $20,000 from Mr. Jones's job, the $5,000 that is left over is the net profit.

This example illustrates that “time” is the key factor. A job can only produce Gross Profit. Net Profit and Overhead is the responsibility of the managers of the company. Net Profit is produced by getting more Gross Profit produced than one's Overhead in a unit of time.

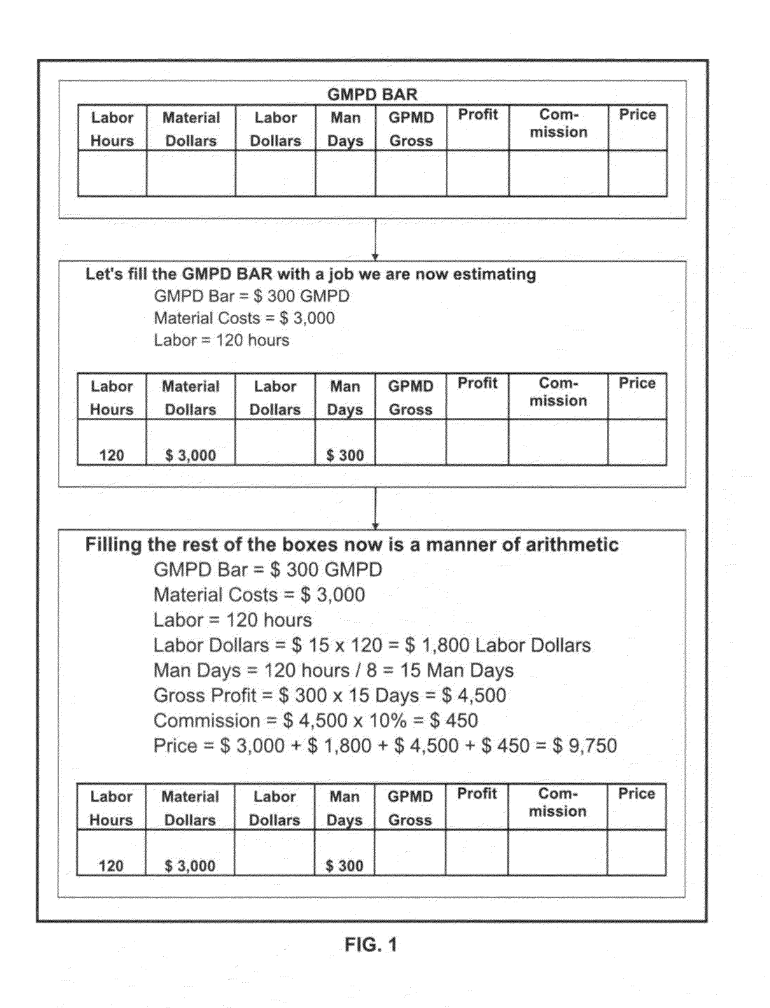

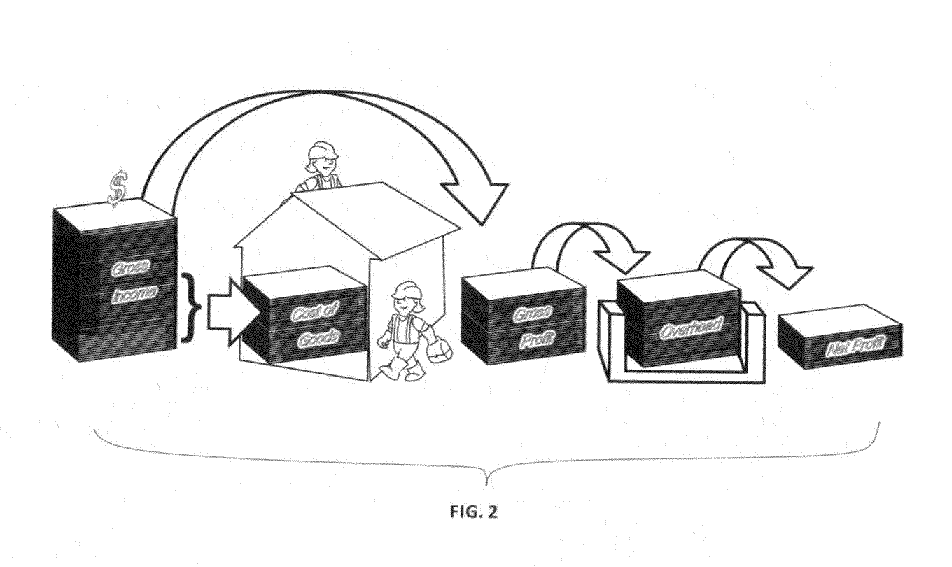

FIG. 1 demonstrates how the system fills in The GPMD Bar with a job that a contractor is estimating with the following:

GPMD=$300 GPMD

Material Costs=$3,000

Labor Hours=120 hours

The rest of the box can now be filled out using arithmetic:

GPMD=$300 GPMD

Material Costs=$3,000

Labor Hours=120 hours

Labor Dollars=$15×120=$1800 Labor Dollars

Man Days=120 hours/8=15 Man Days

Gross Profit=$300×15 Days=$4,500

Commission=$4,500×10%=$450

Price=$3,000+$1,800+$4,500+$450=$9,750

This becomes a very easy way to estimates jobs.

A software has been developed to implement the system. More specifically, a web-based software.

A contractor would subscribe to the software on a monthly basis. He would enter the customer info into the system, do the estimating using the software, then schedule and project the job using the software, make daily adjustments to the schedule, enter the actual labor hours and the actual materials cost into the software, then book the Gross Profit that he actually made at the end of each day.

FIG. 1 further illustrates a GPMD bar filled in. Note only 3 boxes need to be filled in (Labor Hours, Material Dollars,& GPMD) and the rest will automatically calculate.

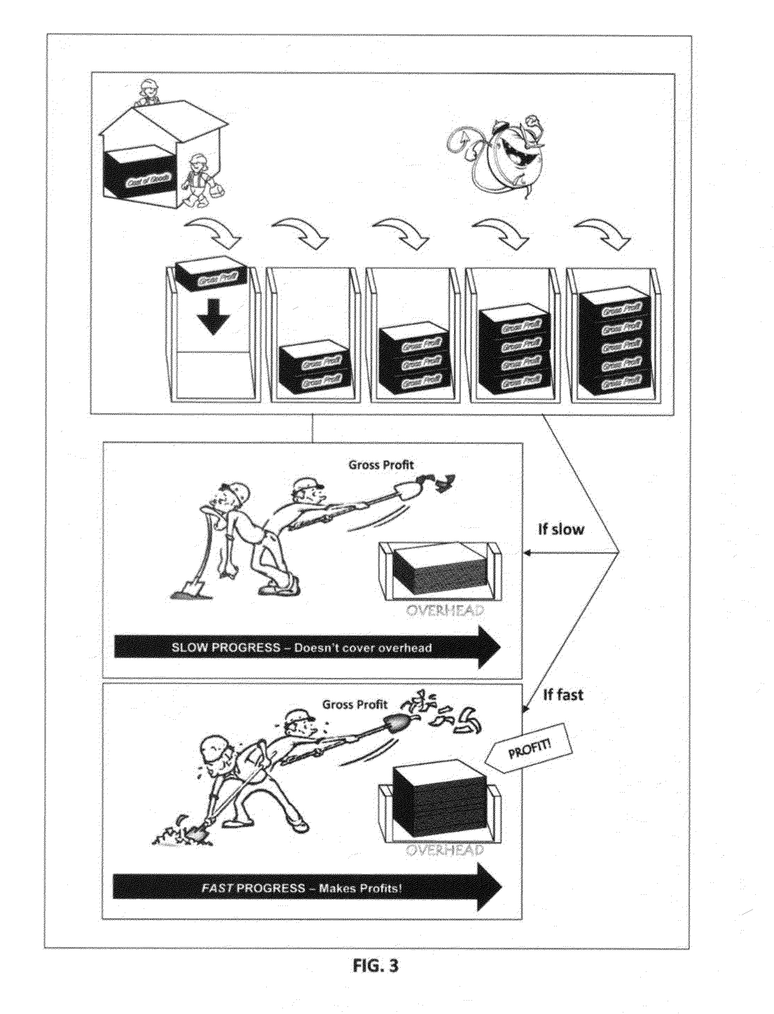

FIG. 2 illustrates the relationship between gross income, cost of goods, gross profit, overhead, and net profit. It depicts the flow from gros income to cost of goods to gross profit to overhead and then ultimately net profit.

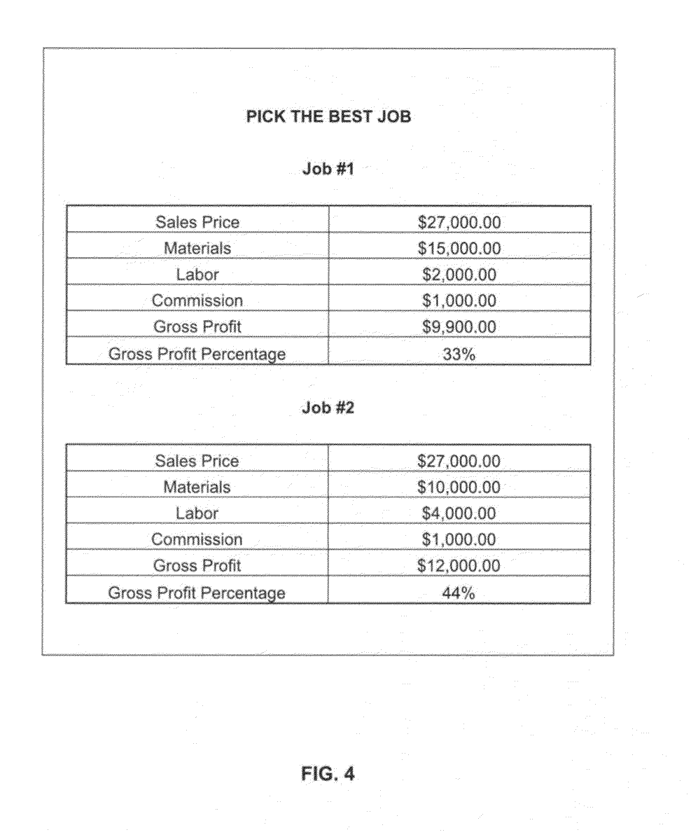

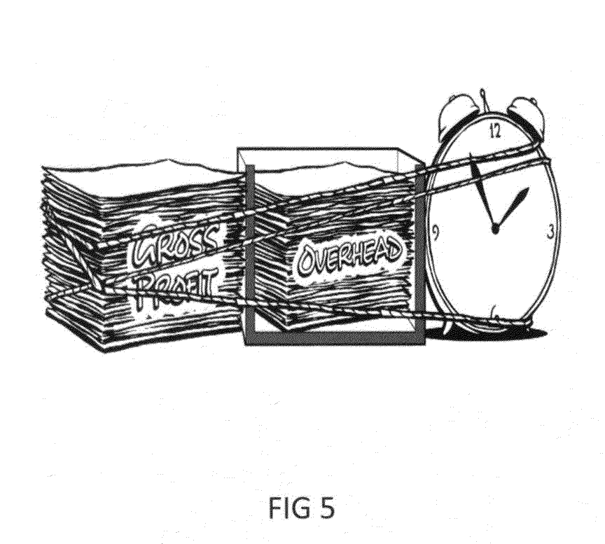

FIG. 3 illustrates ones overhead bin as well as the definition of breakeven which is when the gross profit is equal to the overhead, the ENEMY which is TIME

FIG. 4 illustrates two jobs to choose from. Referring to FIG. 4, the best job to pick is job #1. Because job #1 can be done in half the time of job #2, $2,000 in labor as compare to $4,000 in labor. Using the same labor rate of $15 an hour or $120 a day job #1 would take 16.67 Man Days to complete earning $594 GPMD, while job #2 would take 33.3 Man Days earning $360 GPMD. As can be seen, Gross Profit percent or Gross Profit is not the guiding factor, but time is.

The System's estimating formula only needs to know three things:
1. What the GPMD one wants or needs in order to cover ones overhead (Tying ones Gross Profit to TIME—which is a coined word GPMD (gross profit per man day)/Think of each man as a production unit that produces Gross Profit for the company. And each production unit has its share in the company's Overhead. The GPMD that you expect and demand each crew member to produce must be enough to cover Overhead and give a Net Profit;
2. What the materials costs are; and
3. How many labor hours to do the job.

Once the three numbers above are entered into the GPMD Bar, it will automatically calculate the rest of the numbers as shown in FIG. 1

The GPMD value will also vary depending on:
1. How badly the contractor needs the work (the contractor may be willing to accept less profit).
2. How easy the job is. (The easier the job, the less likely there will be errors or mistakes made and the less supervision will be needed. For example an easy job for a company can be a 1,500 sq. ft. paving stone job that the company have built 1,000 times.)
3. What the competition is at the time.
4. How good the Sales Rep is, a better Sales Rep can sell more Gross Profit.
5. The customer (how difficult they might be)
6. The GPMD number would be controlled by the Operations Division in the company, as they know the workload and know how low they are willing to go to keep the schedule board filled up. As an example $300 GPMD will be used in the examples.

FIG. 5 illustrates how gross profit should be related to time.

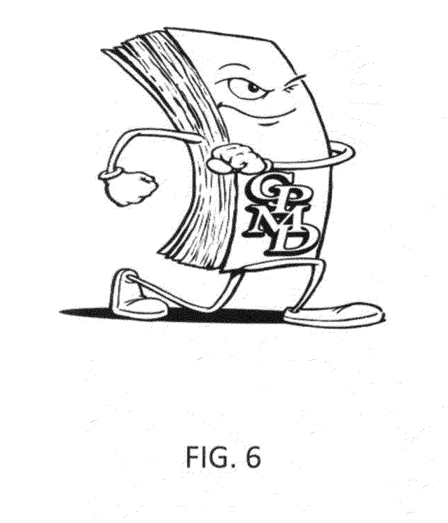

FIG. 6 illustrates a man or a production unit as Gross Profit per Man Day or GPMD

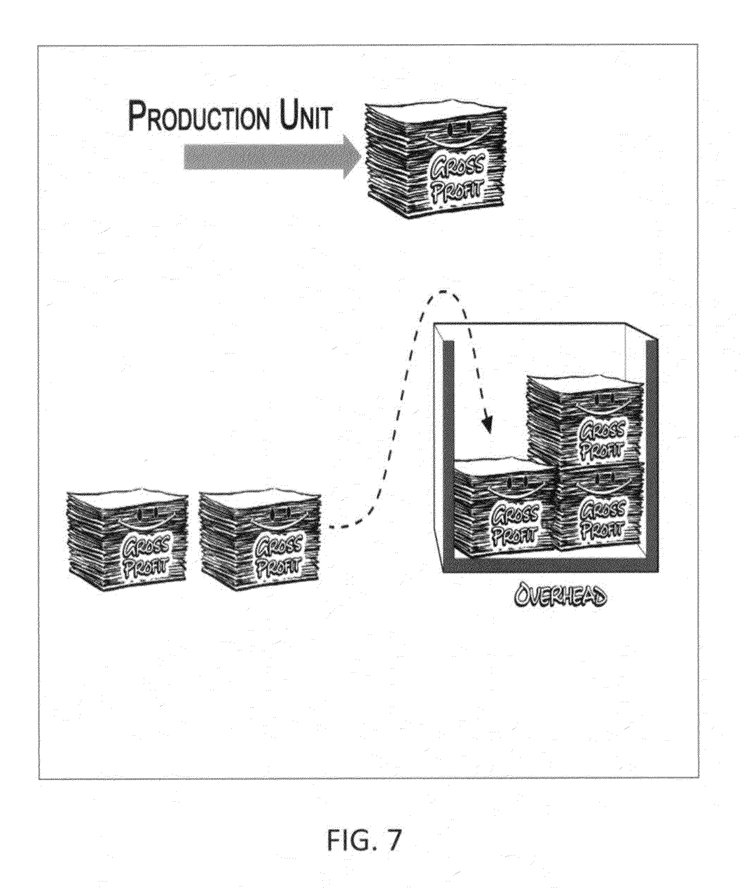

FIG. 7 illustrates a man as a Production Unit and how Production Units are necessary to fill up ones overhead bin.

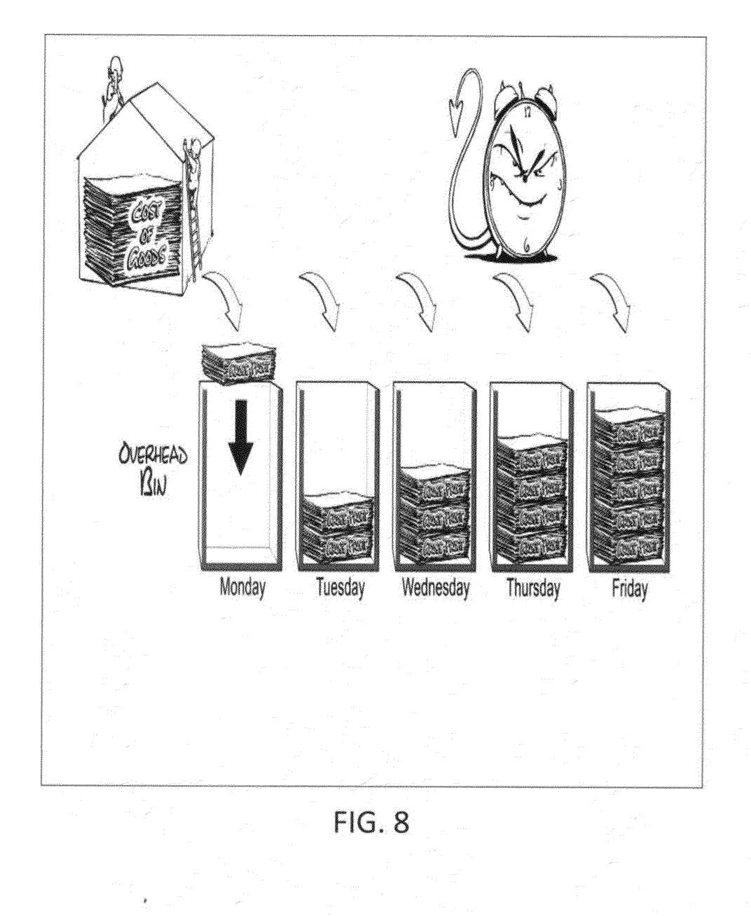

FIG. 8 illustrates how daily gross profit gets added to ones overhead and how it can come up short (not enough gross profit to cover the overhead) even though the estimator added both “overhead” and “profit” to the quote.

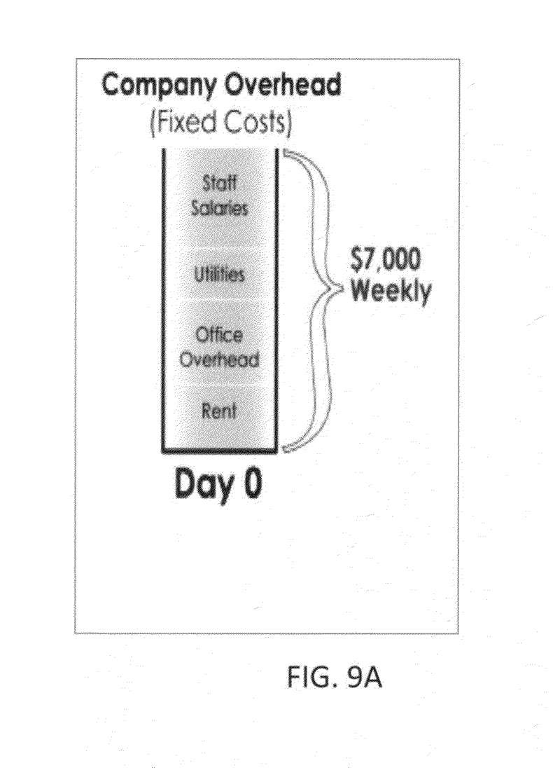

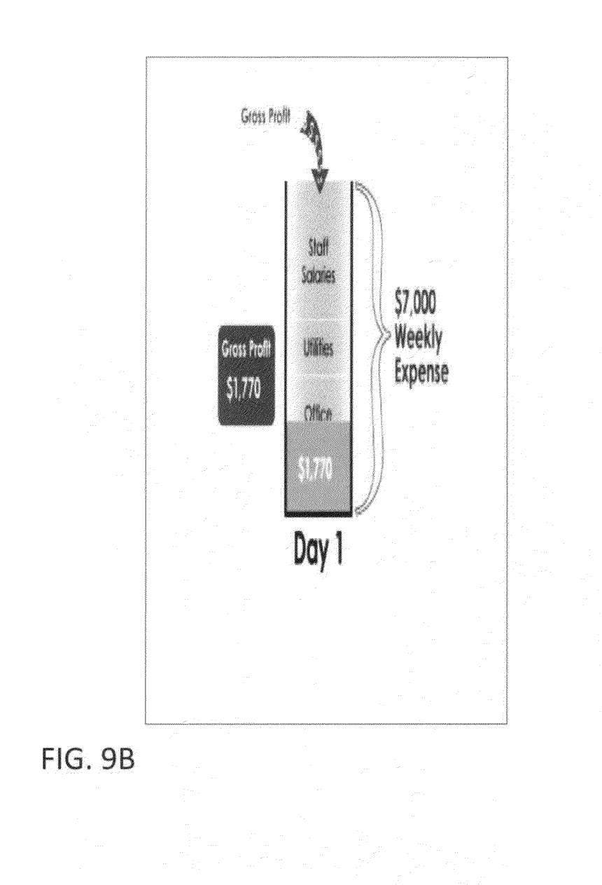

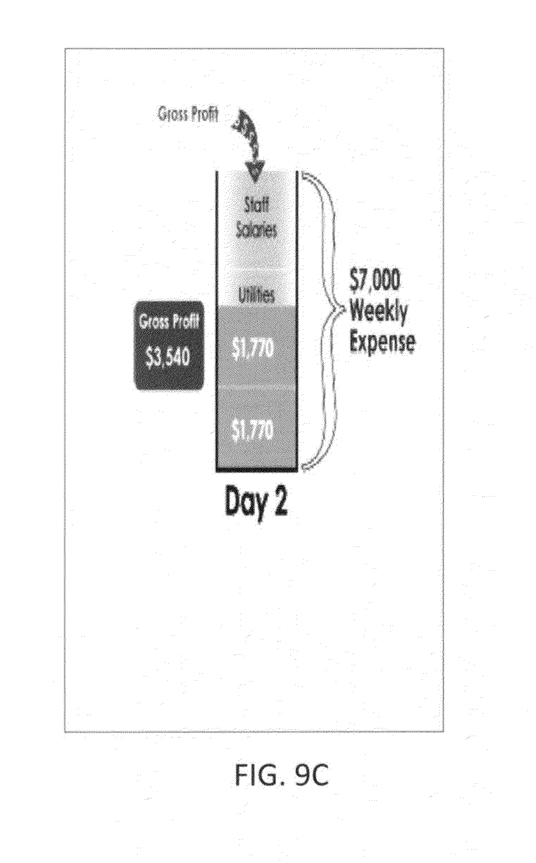

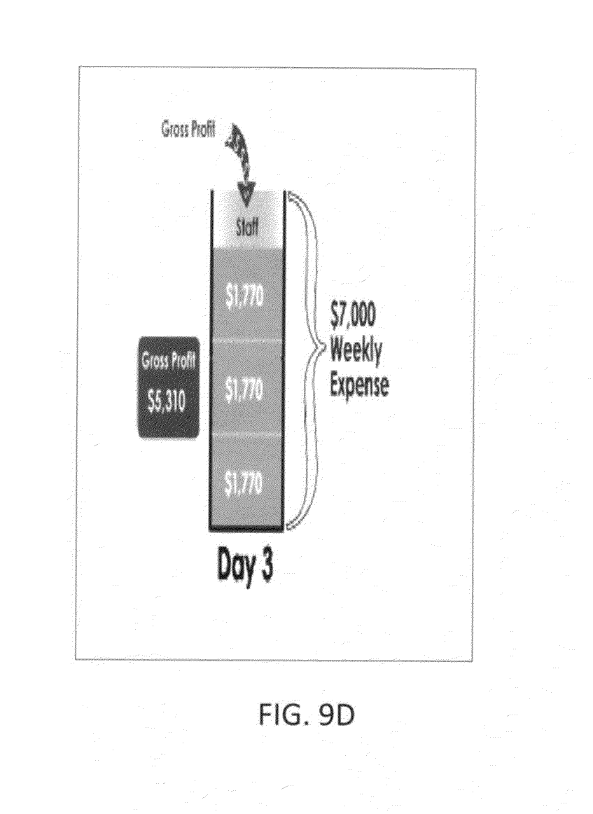

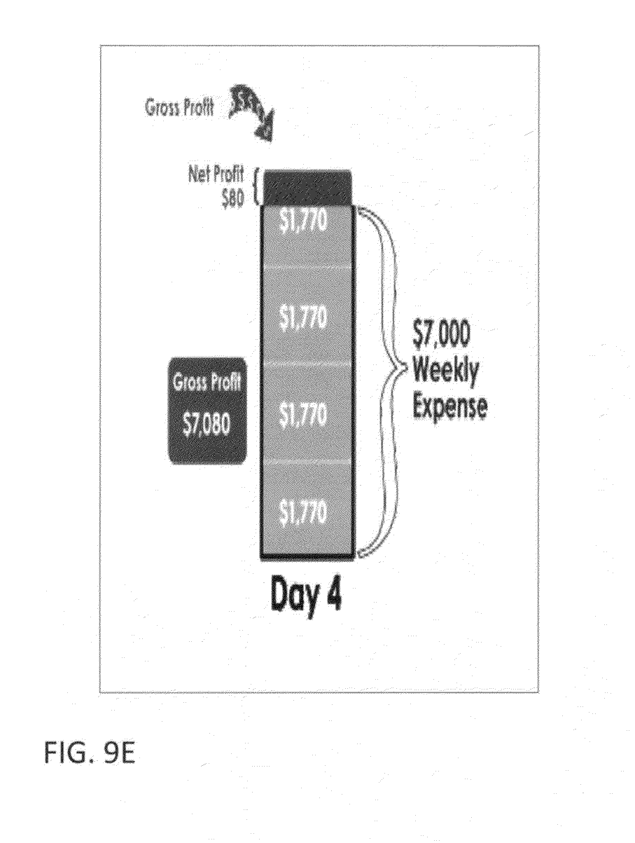

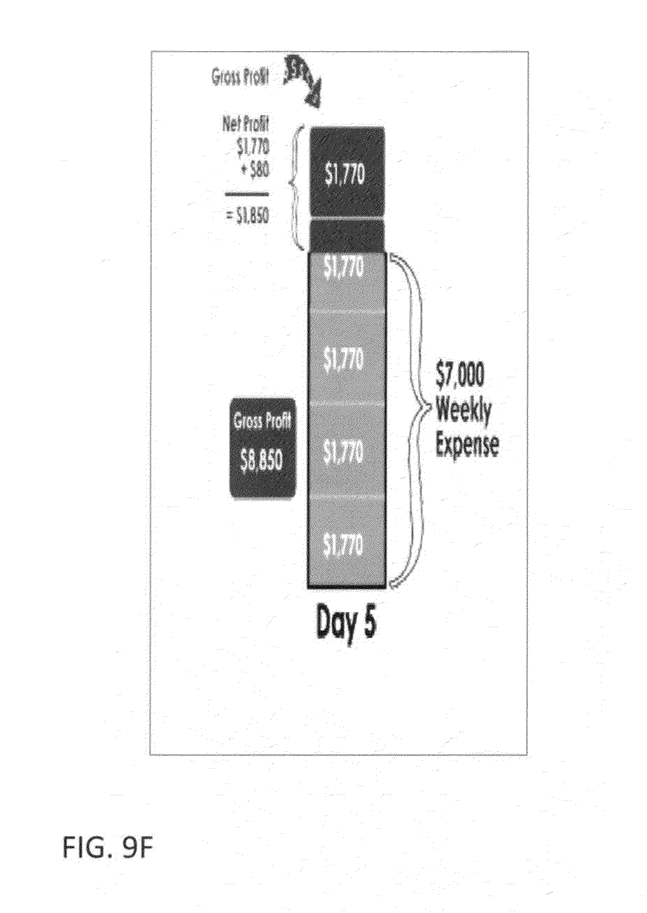

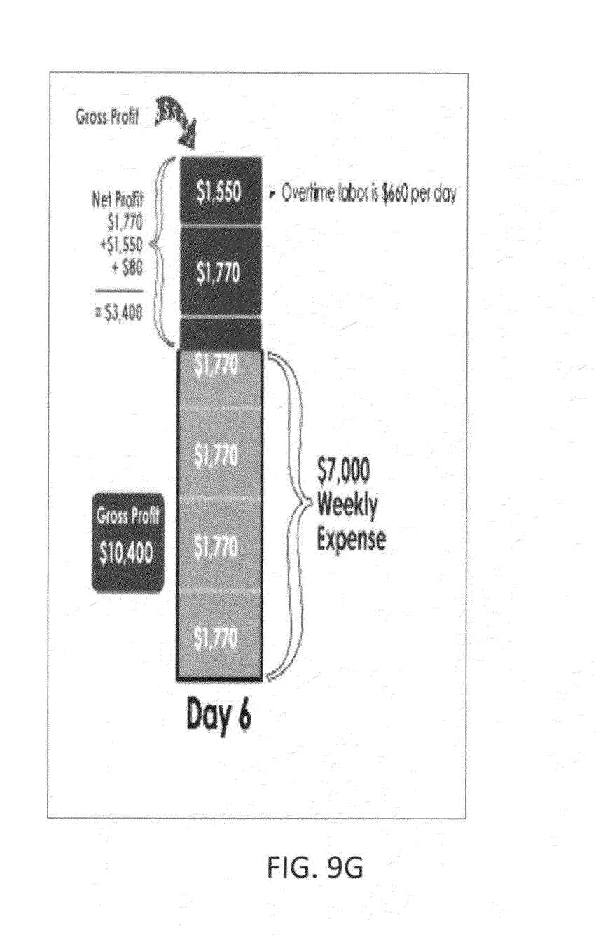

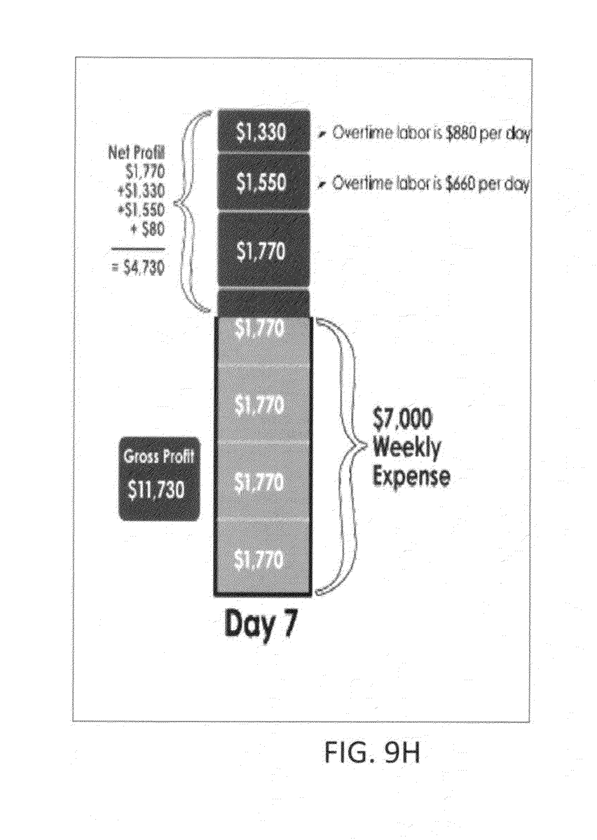

FIG. 9A, FIG. 9B, FIG. 9C, FIG. 9D, FIG. 9E, FIG. 9F, FIG. 9G, and FIG. 9H illustrate using dollar of gross profit earned what happens to the overhead bin each day and it further illustrates what happens on overtime days and double overtime days.

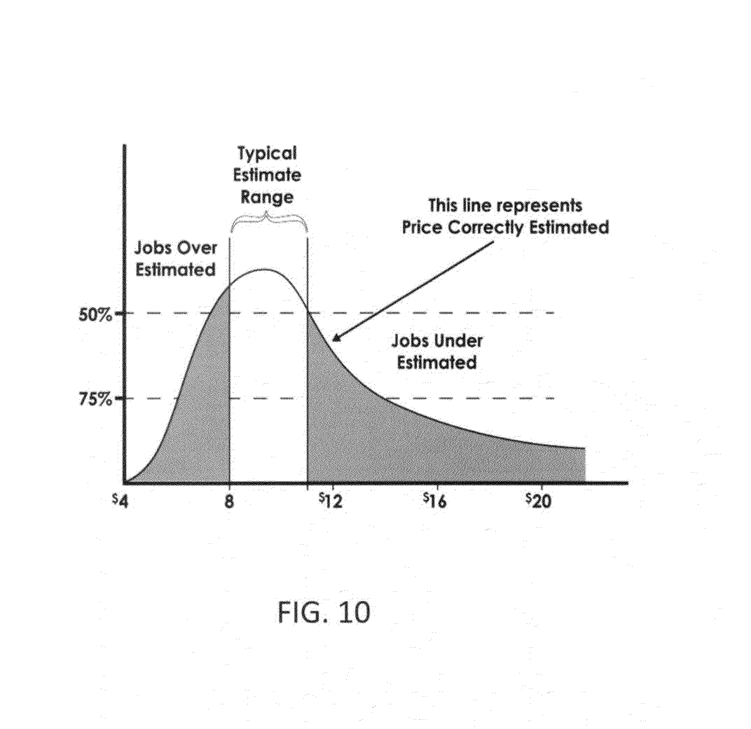

FIG. 10 illustrates the fallacy to bidding by a unit price ($10 per square foot) and how the line on the graph represents the price correctly bid using the GP Estimating System or the AIMM Estimating System.

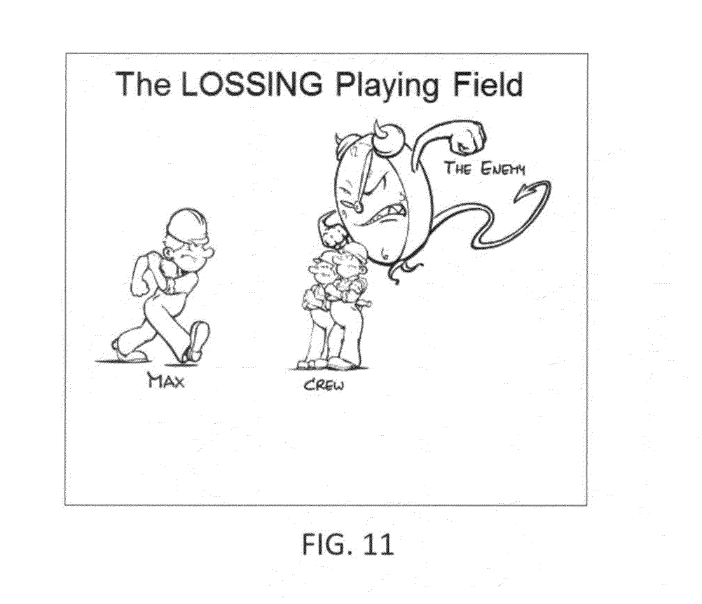

FIG. 11 illustrates a losing playing field where the crews are working for wages not production.

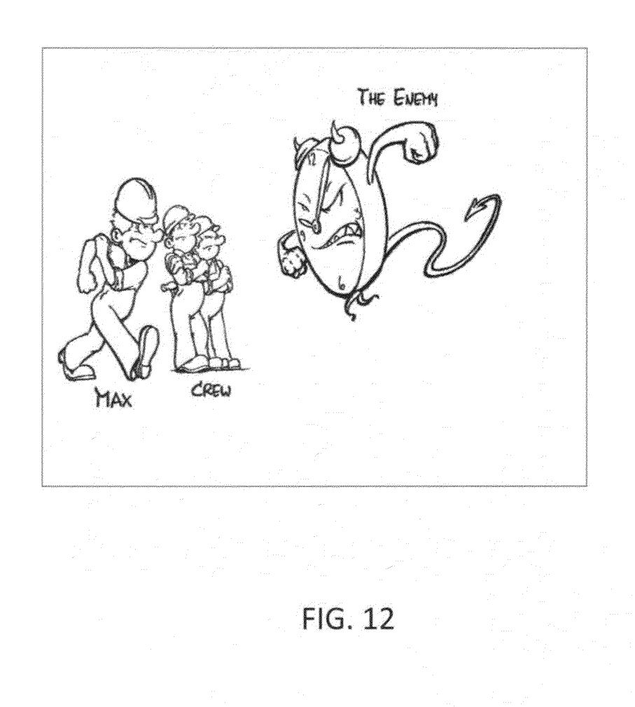

FIG. 12 illustrates the winning playing field where the crews are working with the owner for production and not time.

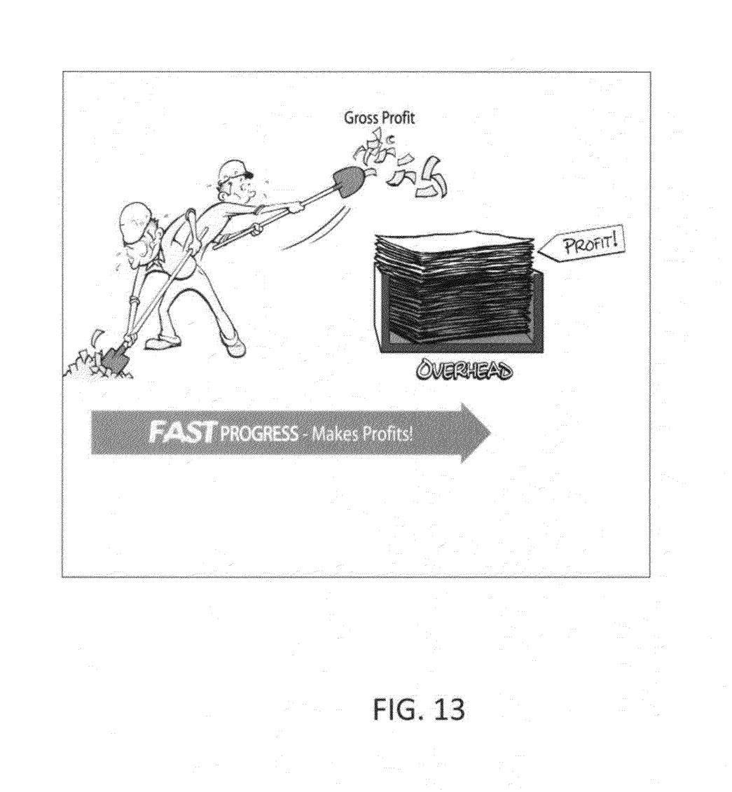

FIG. 13 illustrates faster progress makes profits

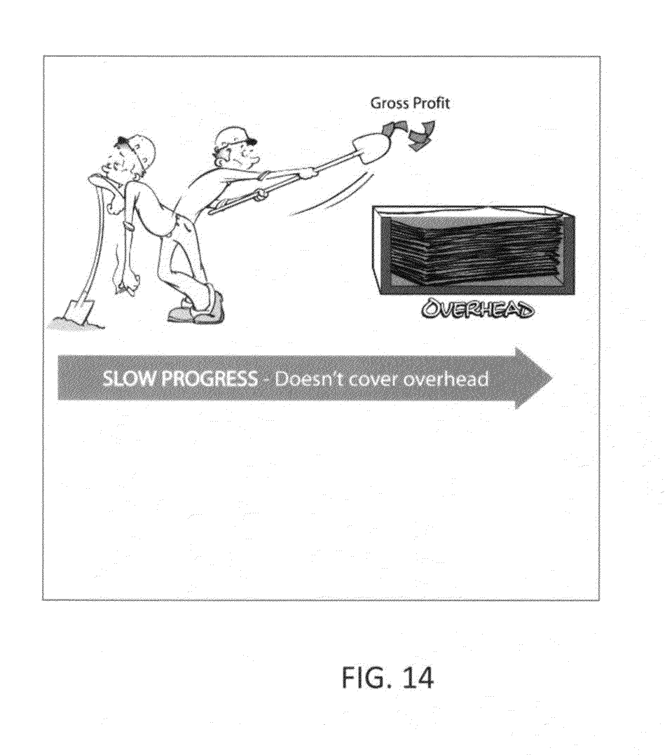

FIG. 14 illustrates slow progress doesn't cover the overhead

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A business method of determining an estimated price and keeping track of a contract job for a contractor, the method comprising:
determining how much labor cost in dollars (a) per hour;
determining how many labor hours required to complete the job;
determining material cost in dollars (b);
determining gross profit per man day (“GPMD”);
determining total labor cost in dollars (c) by multiplying labor cost per hour (a) by the number of labor hours required to complete the job;
determining how many man days;
determining gross profit in dollars (d) by multiplying the “GPMD” by the number of man days;
determining commission in dollars (e);
adding (b), (c), (d), and (e) to get the estimated price of the contract job;
wherein the labor cost per hour (a), labor hours, material cost (b) and “GPMD” are determined by the contractor;
wherein TIME is the missing factor in all estimating systems that use cost per square foot or add a percentage for overhead or for profit;
and wherein a one can produce ONLY gross profit from a job and cannot produce overhead or net profits by simply added a percentage to the estimate. ONLY the mangers of a company can ensure the gross profit that are produced from and job cover the overhead and make a profit.

2. The business method of claim 1, wherein how many man days is determined by dividing the number of labor hours by eight per day.

3. The business method of claim 2, wherein the GPMD is determined and controlled by the contractor and is affected by various factors including but not limited to the type of the job, competition in the market, and customers cooperation.

4. The business method of claim 3, the method further comprising providing a software which is capable of calculating and which presents a table comprising input fields corresponding to labor hours, material cost (dollars), and GPMD respectively for the contractor user to input data, the software calculates the labor dollars, man days, gross profit, commission, and the price based on the data input by the contractor.

5. The business method of claim 4, wherein the commission is calculated based on the calculated gross profit multiplied by a percentage which may be an input made by a contractor depending on the type of job and other factors.

6. The business method of claim 5, the method further providing means for scheduling, projecting the job and making daily adjustments to the schedule, entering the actual labor hours and the actual materials cost into the software and booking the gross profit made at the end of each day.

7. The business method of claim 6, the method further comprising providing a web based software or mobile device application that offers contractor to do the price estimation, schedule and project the job using the software.

8. A business system for determining an estimated price and keeping track of a contract job for a contractor, the system comprising:
a customer information database for contractor to input customer information;
a job scheduler and projector module for inputting jobs and making adjustments to the schedule;
a job price estimator module for estimating the price for a job;
a database for booking the gross profit; and
a database for storing the input labor cost per hour (a), labor hours, material cost (b), GPMD, calculated total labor cost (c), man days, gross profit (d), commission (e).

9. The business system of claim 8, wherein the job price estimator comprising a processor to calculate the price of the job based on the labor cost per hour (a), labor hours required to complete the job, gross profit per man day (“GPMD”), and material cost in dollars (b) that are input by the contractor.

10. The business system of claim 9, wherein the job price estimator calculates the price of the job following the steps of determining total labor cost in dollars (c) by multiplying labor cost per hour by the number of labor hours required to complete the job; determining how many man days; determining gross profit in dollars (d) by multiplying the “GPMD” by the number of man days; determining commission in dollars (e); and adding (b), (c), (d), and (e) to get the estimated price of the contract job.

11. The business system of claim 10, the system further comprising a software to enter the customer info into the system do the estimating using the software, then schedule and project the job using the software, make daily adjustments to the schedule, enter the actual labor hours and the actual materials cost into the software, then BOOK the GP that he actually made at the end of each day.

12. The business system of claim 11, wherein the software is a web based software or mobile device application that offers contractor to do the price estimation, schedule and project the job and storing the data in the database.

13. A software for providing business owner's the ability to know if he is making or losing money on a daily basis comprising:
determining the gross profit man day (“GPMD”) which is depending on various factors; and
estimated job price based on a formula.

14. The software of claim 13, wherein the formula to determine the estimated job price comprising:
getting labor cost per hour;
getting material costs;
getting labor hours to do the job;
calculating labor cost;
calculating man days;
calculating gross profit;
calculating commission; and
calculating price.

15. The software of claim 14, wherein the labor dollars can be calculated by multiplying the labor cost per hour by the total labor hours.

16. The software of claim 15, wherein the man days can be calculated by dividing the total labor hours by eight hours per day.

17. The software of claim 16, wherein the gross profit can be calculated by multiplying the GPMD by the number of man days.

18. The software of claim 17, wherein the commission can be calculated by multiplying the gross profit by a desired percentage of equal to or greater than 1 percent.

19. The software of claim 18, wherein the price to charge for the job is the material cost plus the labor cost plus the gross profit plus the commission.

20. The software of claim 19, wherein the GPMD depending on various factors such as how badly the contractor need the work (contractor may be willing to accept less profit), how easy the job is (the easier the job, the less likely there will be errors or mistakes made and less supervision will be needed. For example, 1,500 sq. ft. paving stone job may be considered an easy job by a contractor if they have built time 1,000 times), what the competition is at the time, how good the sales rep is (a better sales rep can sell more gross profit), and the customer (how difficult they might be).
